(19) United States
(12) Patent Application Publication
(10) Pub. No.: US 2005/0205820 A1
(43) Pub. Date: Sep. 22, 2005

(54) Direct action electromagnetic valve, and a method of operating the same

(76) Inventor: Nikolai Babich, Kiyv (UA)

Correspondence Address: ILYA ZBOROVSKY, 6 SCHOOLHOUSE WAY, DIX HILLS, NY, 11746, US

(21) Appl. No.: 11/135,154

(22) Filed: May 21, 2005

(30) Foreign Application Priority Data
Dec. 29, 2001 (UA) 2001129236

(51) Int. Cl. F16K 31/02

(52) U.S. Cl. 251/129.15

(57) ABSTRACT

An electromagnetic valve has a housing forming a throughgoing passage for a fluid medium, a seat element, an electromagnet having a coil and an armature element which is movable relative to a coil under an action of an electromagnet force between a closed position in which the armature element interacts with the seat element and an open position in which the armature is spaced from the seat element, and a closure seal arranged so that in the closed position it seals one of the elements relative to another of the elements; and also a method of operating the electromagnetic valve is provided.

### BACKGROUND OF THE INVENTION

The present invention relates to devices for closing and opening tubular conduits, and in particular to direct action valves.

More particular, it relates to direct action valves which have an unloaded closing element and can be used in fast-action high-pressure pneumatic/hydraulic equipment.

Direct action electromagnetic valves are widely used due to their simple construction, high reliability and fast action. A probability of their clogging, blocking of movable parts is significantly lower than in the valves of other types. Therefore it is highly recommended to use the direct action valves whenever it is practically possible. The valves of these types are produced, as a rule, with a throughflow cross-section up to 10 mm and a pressure up to 17 kg/cm².

When the valve has a closing device which is unloaded from a one-side pressure of a fluid during its operation, it is not necessary to overcome a full hydrostatic pressure of the fluid acting on the area of the whole throughflow cross-section. This enhances a reduction of dimensions of electromagnetic valves. The closing of the valve as a rule is performed by pressing of a closing element against a seat by means of a return spring and a pressure of the working medium, or by a holding force of an electromagnet, or a combination thereof.

An electromagnetic valve includes a valve housing with a seat, a magnetizing coil of an electromagnet, a spring-loaded armature, and a sealing element. When a current is supplied to a winding of the magnetizing coil of the electromagnet, the armature is displaced and overcomes a force of the return spring and a pressure of a working medium, so as to move with it a sealing element of the closure and to release an opening of the valve seat for passage of the working medium.

When the current is removed from the winding of the magnetizing coil of the electric magnet, the armature under the action of the return spring is moved to its initial position until the sealing element arranged on a side surface of the armature abuts against the valve seat and overlaps the passage in the valve housing.

A coaxial valve is known with a hollow armature, composed of a housing with a seat, a magnetizing coil of the electromagnet, a spring biased armature, and a sealing element disclosed in the publication “Valves with an Electromagnetic Drive”, M, “Energoizdat” 1988, S. K. Schuchinskij, pages 33-35. This valve partially eliminates the disadvantages of the valves with an angular construction of the direct and indirect action. In particular, the coaxial valve has a more compact construction, smaller dimensions and weight, and also the working medium flows through it without directional changes, that reduces a hydraulic resistance. The valve has a fast action time.

A valve of a normally closed type is composed of a valve housing with outlet and inlet pipes and a seat, a closing element which is fixedly mounted on an end of the armature, a return spring, poles, a coil and a hermetization pipe. When the coil is currentless, the armature under the action of the return spring is pressed against the seat of the valve. Pressure on the sealing surfaces of the closing device which provides hermetization in the closure, is provided by a setting force of the return spring. The pressure of the return fluid on an unloaded surface of the closing element enhances the hermetization of the sealing in the closure. The valve is closed. After voltage is supplied to the winding of the magnetizing coil, the armature with the closing element is moved toward the pole. A throughgoing passage in the seat is opened.

However, the efficiency of this valve is not sufficient because with the increase of pressure which is commutated by the valve, for providing a working ability of the valve it is necessary to reduce the area of the end surface of the armature or to increase a force of the return spring. This leads to an increase of pulling and holding force of the electromagnet with a corresponding increase of dimensions and weight of the construction, and also reduction of a service life of a sealing element and reliability of operation of the valve.

### SUMMARY OF THE INVENTION

It is therefore an object of the present invention to provide an electromagnetic valve which eliminates the disadvantages of the prior art.

More particularly, it is an object of the present invention to provide an electromagnetic valve with increased efficiency, due to increased reliability because of increased service life of a seal, with expanded range of use of the valve according to a commutating pressure and flow cross-section due to unloading of the closing device, with a closing seal unloaded from the action of pressure of the working medium, and with reduced of energy consumption of a valve and increased pulling and holding force due to the use of a bistable electromagnetic system with a pulse control.

In keeping with these objects and with others which will become apparent hereinafter, one feature of the present invention resides, briefly stated, in an electromagnetic valve, comprising a housing forming a throughgoing passage for a fluid medium; means forming a seat element; an electromagnet having a coil and an armature element which is movable relative to the coil under an action of an electromagnet force between a closed position in which said armature element interacts with said seat element and an open position in which said armature is spaced from said seat element; and a closure seal arranged so that in said closed position it seals one of said elements relative to another of said elements.

Another feature of the present invention resides in that the closure seal is ring shaped and has an axis coinciding with said axis of said armature.

Still another feature of the present invention resides in that the closure seal is mounted on and movable with said armature element, or the closure seal is mounted on and arranged stationary with said seat element.

Another feature of the present invention resides in that a magnetically hard insert is connected with said seat element and forms a part of a seat cooperating with said armature element, and said closure seal is provided on said magnetically hard insert.

Still another feature of the present invention resides in that the closure seal is mounted on said armature and in said closed position tightly embraces an outer surface of said seat element, or the closure seal is mounted on said seat element and in said closed position tightly surrounds an outer circumferential surface of said armature element.

A further feature of the present invention resides in that the closure seal is mounted on one of said elements and has an annular groove forming a radially outer part and a radially inner part, the other of said elements being engageable in said annular groove in said closed position.

Another feature of the present invention resides in that the closure seal is mounted on one of said elements and is prestressed radially so as to abut against a circumferential surface of the other of said elements with a prestress.

Another feature of the present invention resides in that the closure element is formed elastic, so that when said closure element is mounted on one of said elements it elastically embraces the other of said elements.

Still another feature of the present invention resides in that the armature element has an axis, and said closure seal is ring shaped and has a ring-shaped wall extending in an axial direction.

Still another feature of the present invention resides in that the seat element and said armature element have inclined edges forming chamfers which cooperate with one another in said closed position.

Another feature of the present invention resides in that sealing is means provided between said coil and said armature element.

In the direct current electromagnetic valve in accordance with the present invention a closing device is formed so that it allows to implement a method of closing of the electromagnetic valve in which a closing seal under the action of pressure of a working medium is pressed against the surfaces of the armature and the seat, so as to provide a reliable hermetization of a joint armature-seat and does not counter act its disconnection from one another during opening, so that the operation of the valve is provided with any pressure, limited only by a strength of the valve housing and with any throughflow cross-sections limited only by the desired results.

When on the closing seal there are two ring-shaped projections which in the closed position of the valve surround the outer and the inner cylindrical surface of the armature, the valve can operate as a cut-off valve and at the same time as a return valve, or can prevent a return strike in the system.

The method in accordance with the present invention distinguishes in that mechanical particles which are generally contained in the working medium are not pressed into the material of the seal, but instead are removed by a tangential movement of the armature during closing of the valve, and the flow of the working medium enhances a coaxial connection of the closure and performs the function of a lubricant.

During opening of the valve, when a minimal gap appears between the end surfaces of the armature and the seat of the valve under the action of the working medium which acts on the cylindrical surface of the closing sealing ring, the ring is pressed into the gap and provides pushing of the armature from the seat that increases the speed of action. The valve with the pressure of the working medium can operate without a return speed which increases the reliability. Therefore, the combination of the important new features of the present invention provide highly advantageous results in the increase of operation efficiency, increase of reliability and service life of the valve, and also expansion of a range of application of the valves with direct action, in combination with a bistable electromagnetic system.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an electromagnetic valve of direct action in accordance with the present invention, with an angular arrangement, and with a working element which is unloaded from the action of a working medium and a bistable electromagnetic system with a pulse control;

FIG. 2 is a view showing a coaxial electromagnetic valve with direct action of pressure of the working medium in accordance with the present invention, with a bistable electromagnetic system, with a working element unloaded from the action of a working medium and protection from a return stroke;

FIG. 3 is a view showing a closure device with a seal, of the inventive electromagnetic valve;

FIG. 4 is a view showing sealing of a gap between an armature and a coil in an open position of the electromagnetic valve of the present invention;

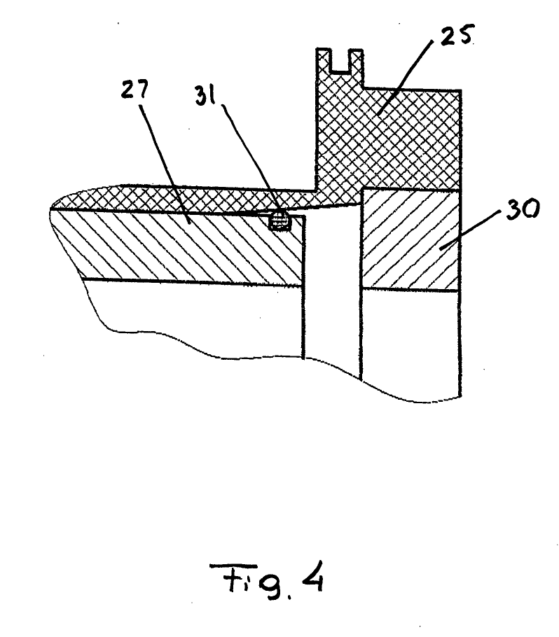

FIG. 5 is a view showing a coaxial electromagnetic valve of direct action with a working element which is unloaded from the action of pressure of a working medium with a bistable electromagnetic system with a pulse control, wherein a close condition of the valve corresponds to a magnetized state of the electromagnet; and

FIG. 6 is a view showing a closure device with a minimum resistance to a flow of the working medium and with an increased area of a magnetic contact.

### DESCRIPTION OF THE PREFERRED EMBODIMENTS

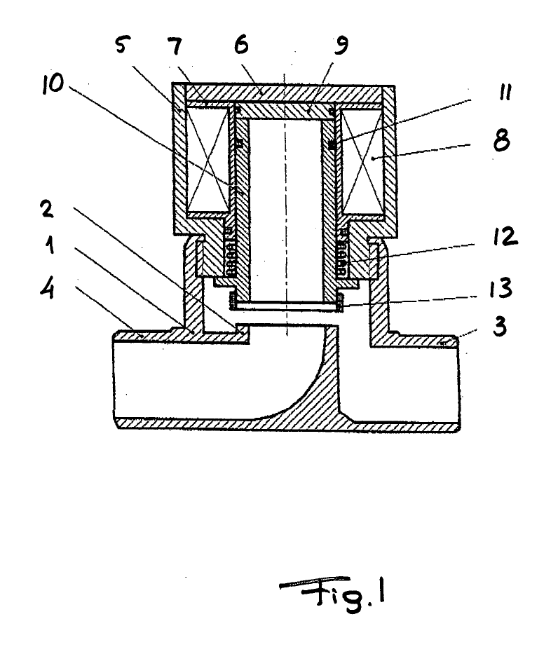

An electromagnetic valve in accordance with the present invention as shown in FIG. 1 is formed as an angular electromagnetic valve. It includes a housing 1 with a flat seat 2, an inlet pipe 3 and an outlet pipe 4 forming a throughgoing passage. The electromagnetic valve further has a bistable electromagnet which includes a cylindrical cup 5 with the bottom 6, and a magnetizing coil 7 with a winding 8 arranged in it.

A magnetically hard insert 9 and a hollow armature 10 of the electromagnet are located in an axial passage of the magnetizing coil. The hollow armature 10 on its outer cylindrical surface is provided with a ring-shaped groove with a sealing ring 11. The armature is provided with a return spring 12 and a closure seal 13.

The electromagnetic valve shown in FIG. 1 has a working element which is unloaded from the action of pressure of a working medium and a bistable electromagnetic system with a pulse control. It operates in the following manner.

When a short-term current pulse is supplied into the winding 8 of the magnetizing coil 7, the hollow armature 10 under the action of a magnetic flux is displaced toward the magnetically hard insert 9, while overcoming a force of the return spring 12 and a friction force of the closure seal 13 against a cylindrical surface of the seat 2, as well as a friction force of the sealing ring 11 relative to the inner surface of the magnetizing coil 7. When the armature closes a magnetic flux, it is fixed in the extreme upper position. The valve is closed.

Thereafter, when a zeroing pulse is supplied into the winding 8 of the magnetizing coil 7, the electromagnet is demagnetized. As a result, the armature 10, under the action of the return spring 12 is displaced toward the seat 2. When the end surface of armature 10 is brought in contact with the surface of the seat 2 of the valve, the pressure in the inner chamber at the side of the inlet pipe 3 significantly increases, and the closure seal 13 is pressed against the outer cylindrical surface of the seat 2. The valve is closed.

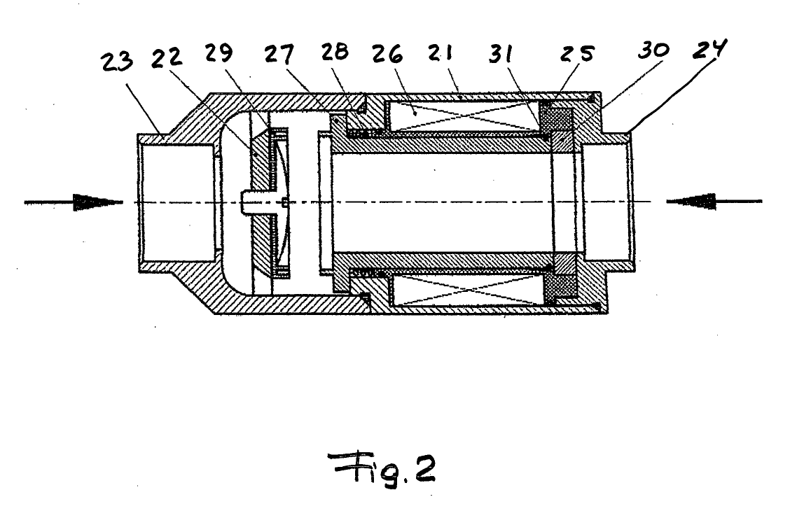

The electromagnetic valve shown in FIG. 2 is a coaxial electromagnetic valve of direct action, with a bistable electromagnetic system, with a working element which is unloaded from the action of pressure of the working medium and a protection from a return stroke. It includes a housing 21 with a solid seat 22, an inlet pipe 23 and an outlet pipe 24. The electromagnetic valve further has a magnetizing coil 25 with a winding 26, a hollow armature 27 with a return spring 28, a plate-shaped seal 29, a magnetically hard insert 30 of a bistable electromagnet, and a sealing ring 31 for sealing a gap between the armature and the coil.

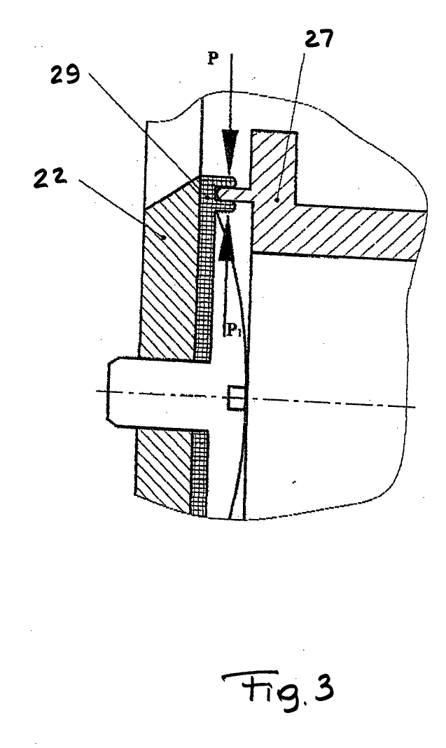

The electromagnetic valve shown in FIG. 2 operates in the following manner. When a short-term pulse of current is supplied to the winding 26 of the magnetizing coil 25, the hollow armature 27 under the action of the magnetic flux is displaced toward the magnetically hard insert 30, with overcoming of a force of the return spring 28. It closes the magnetic flux and is fixed in a position which is remote at a maximum distance from the seat 22. The valve is open. When a short-time pulse of opposite polarity is supplied into the winding 26 of the magnetizing coil 25, the magnetically hard insert 30 is demagnetized, and the armature 27 under the action of the return spring 28 is displaced toward the seat 22. When the ring-shaped projection of the armature 27 is inserted into a ring-shaped groove 32 of the closure seal 33, the pressure in the inlet pipe 23 increases significantly and acts on the closure seal 33 so as to press it against the cylindrical surface of the ring-shaped projection at the end of the armature 27 with a force P shown in FIG. 3. The valve is closed.

If the flow of the working medium through the valve is reversed, it hermetically cooperates with the outer or the inner ring-shaped projection of the closure seal 33, depending on the direction of the flow, while the other ring-shaped projection operates as a return valve.

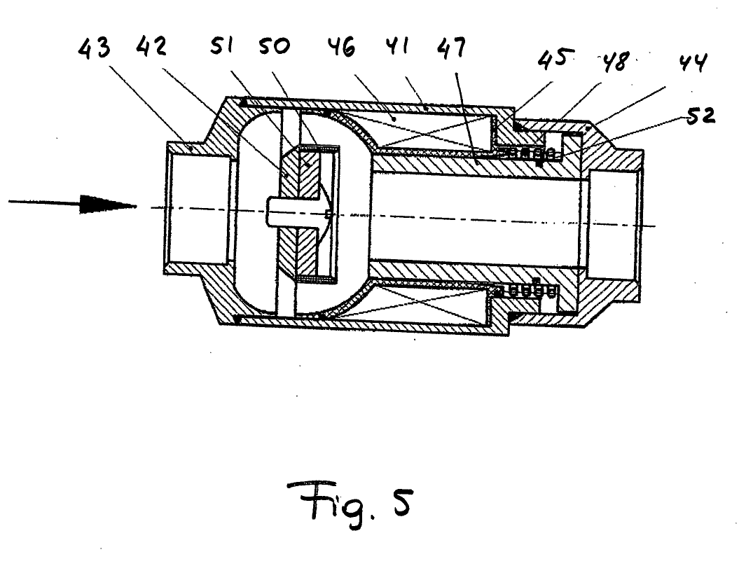

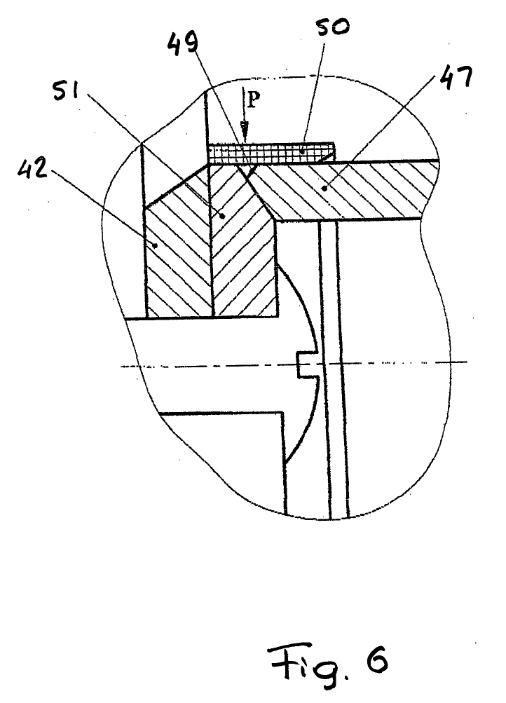

FIG. 5 shows a coaxial electromagnetic valve of direct action, with a working element which is unloaded from the action of pressure of the working medium, with a bistable electromagnetic system and a pulse control. Here, the closed condition of the valve corresponds to a magnetized state of the electromagnet. The electromagnetic valve has a housing 41 with the seat 42, an inlet pipe 43 and an outlet pipe 44. It further has a magnetizing coil 45 with a winding 46, a hollow armature 47 with a return spring 48 and a chamfer 49 shown in FIG. 6. The electromagnetic valve further has a ring-shaped closure seal 50 arranged on the magnetically hard insert 51, and a sealing ring 52 for sealing a gap between the armature and the coil. In the embodiment of FIG. 5 the magnetically hard insert forms a part of a composite seat since it cooperates with the armature of the electromagnetic.

The valve shown in FIG. 5 operates in the following manner. When a short-term controlling pulse is supplied to the winding 46 of the coil 45, the hollow armature 47 under the action of the magnetic flux moves towards the seat 42, while the magnetic flux provides centering of the armature 47 relative to the seat 42 with the closure seal 50. A flow of the working medium spreads a free part of the closure seal 47 and contributes to the coaxial connection of the closure. When the end surface of the armature 47 is brought in contact with the surface of the seat, the flow is interrupted. The pressure in the inlet pipe 43 significantly increases and presses the closure seal 50 so as to provide a hermetic closure under the action of the force P shown in FIG. 6. The gap between the armature and the coil is sealed by the sealing ring 52 located in a ring-shaped groove on the cylindrical surface of the armature 47. The valve is closed.

When a pulse with an opposite polarity is supplied into the winding 46 of the magnetizing coil 45, the electromagnetic system is demagnetized. The armature 47 under the action of the return spring 48 and pressure of the working medium which presses the closure seal 50 with the force P into a gap formed between the end surfaces of the armature 47 and the seat 42 and also the flow of the working medium directed in the same direction, is accelerated and is displaced to a position which is spaced at the maximum distance from the seat 42. The valve is closed.

When the valve in its closed position is subjected to a longitudinal strike from the side of the inlet pipe 43, the armature 47 under the action of inertia forces overcomes a holding force of the permanent magnet, interrupts a closed magnetic flux and opens. A maximum speed of action of the force is provided as a result of the inertia force of the armature 45 which depends on speed in the moment of strike, with a force generated by the return spring 48, and also the force P which tries to press the closure seal 50 into the gap formed between the armature 47 and the seat 42 depending on the size of the chamfer 49 and also from the speed of the flow which accelerates the armature 47 in the same direction. This allows to use the valve in automotive industry for filling airbags. The valve itself performs the function of an inertia sensor, which also increases the speed of the action, eliminates false responses and increases the reliability of the system. When several valves oriented in different directions are installed in a vehicle, it is possible to fill the airbags exclusively from the side of the strike with a maximum speed of action and reliability of response.

The advantages of the proposed method of closing of the electromagnetic valve of direct action include a completely new principle of closing which provides a complete independence of the valve from the action of pressure of the working medium, which in turn allows to significantly increase a diameter of a passage. In combination with the bistable electromagnetic system it provides a significantly greater pulling force, a correspondingly longer stroke of operation, an increase range of use of valves of with direct action without consumption of energy. It also simplifies the construction, reduces weight and increases sizes. The valves can be unified by combining normally closed and normally opened valves with power supply from direct current and alternating current. It is also possible to use it simultaneously as cut-off, return and safety valves.

The valve has a lower weight than conventional valves. The prior art valve, with the diameter of a passage 12 mm and pressure of the working medium 2.5 kg/cm² weighs 3.9 kg. The valve with the diameter of a passage 25.4 mm and the working pressure 16 kg/cm² which is designed in accordance with FIG. 5 has a weight of only 0.8 kg. This provides therefore five times reduction of metal consumption, with characteristics of pressure and passage, which are significantly higher.

The increase of service life of the closure in the valve as a whole results from the fact that the seal is not pressed against the seat and correspondingly there is no deformation of the seat. An additional result is a possibility of operation of the valve with dirtier media, and also an increase in the speed of action of the valve.

In the electromagnetic valve of the present invention its electromagnetic system and the method of electromagnetic electromagnetic actuation are those which are disclosed in our U.S. patent application Ser. Nos. 10/192,523; 10/500,409; and 10/791,047 which are incorporated here by reference.

It should be mentioned that the closure seal 7 is configured so that it can be somewhat prestressed toward an element with which it cooperates. For example, the inner diameter of the closure seals shown in FIGS. 1, 5 and 6, and also the inner diameter of a radially outer portion of the closure seal shown in FIG. 2 can be somewhat smaller than the outer diameter of a corresponding part of the armature, so that when the closure seal is engaged with the armature, it rests on its outer circumferential surface with a pre-stress. In the embodiment shown in FIG. 2 the outer diameter of the radially inner part of the closure seal can be somewhat greater than the inner diameter of a part of the armature with which it cooperates so as to provide a radially outer prestress.

Also, the closure with seal can be somewhat inclined or in other words made cone-shaped with a diameter reducing toward the corresponding part of the armature, for the same purpose of providing the prestress and increased tightness between the closure seal and the armature and therefore between the seat and the armature.

It is to be understood that the closure seal can be formed elastic, of example for elastic rubber or elastic plastic to enhance the sealing functions.

It will be understood that each of the elements described above, or two or more together, may also find a useful application in other types of constructions differing from the types described above.

While the invention has been illustrated and described as embodied in a direct action electromagnetic valve, and a method of operating the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An electromagnetic valve, comprising a housing forming a throughgoing passage for a fluid medium; means forming a seat element; an electromagnet having a coil and an armature element which is movable relative to said coil under an action of an electromagnet force between a closed position in which said armature element interacts with said seat element and an open position in which said armature is spaced from said seat element; and a closure seal arranged so that in said closed position it seals one of said elements relative to another of said elements.

2. An electromagnetic valve as defined in claim 1, wherein said armature element has an axis, said closure seal being ring shaped and having an axis coinciding with said axis of said armature element.

3. An electromagnetic valve as defined in claim 1, wherein said closure seal is mounted on and movable with said armature element.

4. An electromagnetic valve as defined in claim 1, wherein said closure seal is mounted on and arranged stationary with said seat element.

5. An electromagnetic valve as defined in claim 1, wherein said electromagnet has a magnetically hard insert which is connected with said seat element and forms a part of a seat element, which cooperates with said armature element, said closure seal being provided on said magnetically hard insert.

6. An electromagnetic valve as defined in claim 1, wherein said closure seal is mounted on said armature and in said closed position tightly embraces an outer surface of said seat element.

7. An electromagnetic valve as defined in claim 1, wherein said closure seal is mounted on said seat element and in said closed position tightly surrounds an outer circumferential surface of said armature element.

8. An electromagnetic valve as defined in claim 1, wherein said closure seal is mounted on one of said elements and has an annular groove forming a radially outer part and a radially inner part, the other of said elements being engageable in said annular groove in said closed position.

9. An electromagnetic valve as defined in claim 1, wherein said closure seal is mounted on one of said elements and is prestressed radially so as to abut against a circumferential surface of the other of said elements with a prestress.

10. An electromagnetic valve as defined in claim 1, wherein said closure element is formed elastic, so that when said closure element is mounted on one of said elements it elastically embraces the other of said elements.

11. An electromagnetic valve as defined in claim 1, wherein said armature element has an axis, said closure seal being ring shaped and having a ring-shaped wall extending in an axial direction.

12. An electromagnetic valve as defined in claim 1, wherein said seat element and said armature element have inclined edges forming chamfers which cooperate with one another in said closed position.

13. An electromagnetic valve as defined in claim 1, wherein said armature element has an axis, said closure seal being mounted on one of said elements and extending in an axial direction toward the other of said elements.

14. An electromagnetic valve as defined in claim 1; and further comprising sealing means provided between said coil and said armature element.

15. An electromagnetic valve as defined in claim 1, wherein said armature element is formed as a hollow cylindrical element having an an axial end facing toward said seat element, said closure seal being provided between said axial end of said armature element and said seat element.

16. A method of operating an electromagnetic valve, comprising the steps of forming in a housing a throughgoing passage for a fluid medium and a seat; providing an electromagnet having a coil and an armature element; moving said armature element relative to a coil under an action of an electromagnet force between a closed position in which said armature element interacts with said seat element and an open position in which said armature is spaced from said seat element; and one of said elements relative to another of said elements in the closed position by a closure seal.
